(19) United States
(12) Patent Application Publication
(10) Pub. No.: US 2004/0167929 A1
(43) Pub. Date: Aug. 26, 2004

(54) Biometric information submittal and storage system

(75) Inventors: Patrick John Osborne, Davidsonville, MD (US); Chris Smith, Fredericksburg, VA (US); Steven Robert Leary, Bristow, VA (US); Eric Whisman, Stafford, VA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: American Associate of Airport Executives

(21) Appl. No.: 10/705,771

(22) Filed: Nov. 12, 2003

Related U.S. Application Data
(60) Provisional application No. 60/425,270, filed on Nov. 12, 2002.

(51) Int. Cl. G06F 7/00

(52) U.S. Cl. 707/104.1

(57) ABSTRACT

Embodiments of the present invention provide a system and method that enable several functions. These enabled functions include receiving biometric information, verifying key information on the submittal, providing an accounting function for numerous submitting entities, storing the appropriate information, forwarding the information to the proper government agencies, updating the customer web site, providing a full customer service center and full accounting reconciliation for multiple government agencies.

### CROSS REFERENCE TO RELATED APPLICATIONS

The present invention claims priority from U.S. Provisional Application No. 60/425,270 filed on Nov. 12, 2002, the subject matter of which is hereby incorporated by reference in full.

### STATEMENT REGARDING SPONSORED RESEARCH OR DEVELOPMENT

Not Applicable.

### REFERENCE TO SEQUENCE LISTING

Not Applicable.

### BACKGROUND OF THE INVENTION

1. Field of the Invention

Embodiments of the present invention relate to a system and method for accepting, storing, and verifying biometric information for forwarding to appropriate government agencies and for providing secure access to the stored biometric information.

2. Brief Summary Of The Invention

The collection and use of biometric information such as photographic images, fingerprints, blood type, iris image, gene sequence, etc. are relatively well known. For instance, U.S. Pat. No. 6,018,739 (the “'739 patent”) for A DISTRIBUTED BIOMETRIC IDENTIFICATION SYSTEM AND ARCHITECTURE FOR RAPIDLY IDENTIFYING INDIVIDUALS USING FINGERPRINT AND PHOTOGRAPHIC DATA, issued to McCoy, et al. on Jan. 25, 2000, provides an architecture having a centralized server coupled to a plurality of distributed client workstations by way of a wide area telecommunications network. The server and client workstations in the '739 patent further contain subsystems that cooperate to provide personnel identification services to users of the system. The distributed biometric identification system then rapidly identifies personnel based on the use of biometric or other unique identification data. The '739 patent” further provides that this system may serve as an integrated, front-end automated fingerprint and photographic identification tool that supports comprehensive application processing and administrative systems, such as those of various government agencies. However, this and other known biometric information storage systems contain many deficiencies.

In an increasingly dangerous world, issues of security are becoming ever more important. In the airline and other travel industries, it is desired (and in fact now required by law) to verify the identities of current and prospective employees and to provide information as needed to perform background checks on these individuals. Furthermore, it would be advantageous to allow private and public employers to access biometric records on cleared individuals (i.e., those people previously positively identified and approved to work in sensitive transportation positions), thereby avoiding the need to re-clear people with every job change. The database further enables employers to quickly fill position with cleared workers without having to wait the sometimes-lengthy periods required for clearance of new workers.

The reliable and accurate clearance of workers further imposes further requirements on a biometric storage and access system. In particular, the information contained in the system should be verified at time of submission to ensure its sufficiency as needed for various background checks. Otherwise, further delays and costs are incurred as the biometric information must be reobtained, restored, and reforwarded, and retested in the various background checks.

The biometric information storage and retrieval system should further allow various designated groups to access and update information and searches as needed to provide security to travelers. Otherwise security risks arise where a previously cleared individual could continue to work even after the discovery of adverse information.

### BRIEF SUMMARY OF THE INVENTION

In response to these and other needs, embodiments of the present invention provide a system and method that enable several functions. These enabled functions include receiving biometric information, verifying key information on the submittal, providing an accounting function for numerous submitting entities, storing the appropriate information, forwarding the information to the proper government agencies, updating the customer web site, providing a full customer service center and full accounting reconciliation for multiple government agencies.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 illustrates block diagrams of a biometric information storage system in accordance with an embodiment of the present invention; and

FIG. 2 represents the steps in the operation of the biometric information storage system of FIG. 1.

### DETAILED DESCRIPTION OF A PREFERRED EMBODIMENT

Referring now to FIG; 1, one embodiment of the present invention provides a biometric storage system 10 having a database subsystem 100, a supplier access subsystem 110 that accepts or provides biometric information from suppliers 130, and regulatory access subsystem 140 that forwards biometric information to appropriate regulatory agency 150 such as the Transportation Security Administration (TSA) or the Office of Personnel Management (OPM) and policing agency 151 such as the Federal Bureau of Investigations. Embodiments of the present invention may further include an integrated billing system 160 that monitors use to the biometric storage system 10 and charges appropriate fees for the specific uses.

The biometric database 100 stores the biometric information forwarded by employers and the results of the checks performed by the regulatory and policing agencies 150 and 151. The biometric database 100 may further contain entries associating the biometric data with the submitting entity, the status of the biometric data, the identity of the individual associated with the biometric data, and other needed information such as the position sought by the individual and release information.

The biometric information in the Biometric database 100 generally complies with requirements for analysis and processing. For information processed by the FBI, the biometric information complies with the Criminal Justice Information Services' (CJIS) Electronic Fingerprint Transmission Specification (EFTS). For more information, please refer to http://www.fbi.gov/hq/cjisd/ iafis/efts 70.pdf, the subject matter of which is hereby incorporated by reference.

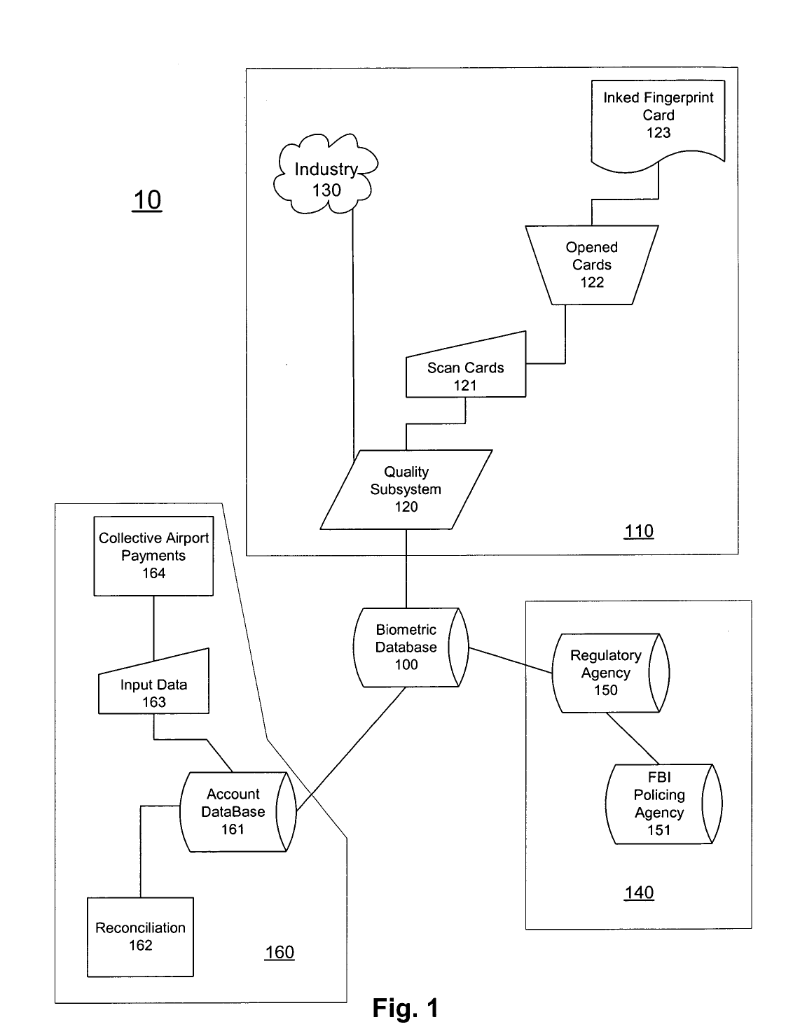

Continuing with FIG. 1, embodiments of the present invention have two primary ways to receive biometric information, on an inked fingerprint card or in electronic format. An electronic submittal from the employers may be sent from the suppliers 130 using Simple Mail Transfer Protocol (SMTP). In general, this electronic submittal may be sent either though a dial-up connection or via a Virtual Private Networking (VPN) connection over the Internet to the biometric database 100.

Once the electronically stored biometric information arrives, a quality subsystem 120 automatically performs quality checks to verify the submission meets the EFTS. With fingerprints, the quality subsystem 120 scores the individual fingerprint images to achieve an average image score to identify likely unclassifiable submissions. If errors may be detected, automatic corrections may be applied to those than can be corrected contacting the submitting employer. Those submissions requiring additional information may be stored and the submitting employer may be automatically notified, generally by e-mail, of the error. Manual corrections may be applied as needed to address the detected errors or deficiencies. Where electronically stored biometric information does not satisfy the EFTS, the information may be modified, converted, enhanced, etc. using known image and data processing techniques. The quality subsystem may be developed using NISTPack source code by Aware, Inc., and multiple processes may be run in order to process a submittal. For more information, please refer to http://www.aware.com/products/compression/nistpack.html.

Referring now back to FIG. 1, an employer may forward an inked card 123 (or other tangible representation of biometric information such as a photograph or biological sample). The inked cards 123 are opened and the opened cards 122 are reviewed to verify that all mandatory fields may be filled out and that all processing The inked cards may be then optically scanned and converted to an electronic file 121 in the EFTS format, and transmitted into the Clearinghouse system as an electronic submission of an inked card using Simple Mail Transfer Protocol (SMTP). When received electronically, the database storing the original manually entered data may be updated as “EFTS Received” and full reconciliation of processed inked cards may be maintained. From that point forward, inked cards may be handled in the same manner as electronic submissions.

The employers may further access certain portions of the database 100 to view the biometric data of potential employees for that employer. To preserve confidentiality, access to the information in the database 100 may be limited to data entries associated with that employer.

Access to the database 100 is typically provided by a secure website served over the Internet. In one embodiment, the website may be continually updated with information on the status of submittals. For instance, the site may be updated once a submittal may be entered into the system 10, when the data is sent to the regulatory agency 150, when the regulatory agency 150 acknowledges receipt of the submittal, and when the results may be posted. All updates may be processed automatically either by the various subsystems described herein or by special programs designed to take data sent to and from the from the regulatory agency 150. Thus, the submitting entities may log into the supplier access subsystem 110, register their applicants, make payment (described in greater detail below), submit fingerprints (or other biometric data) and release paperwork.

Embodiments of the present invention also have the ability to return results to submitting entities, such as a Pass/Fail status. For instance, the submitting entities logging onto the supplier access subsystem 110 may further receive a Pass/Fail results. The Submitting entities can also track the progress of their applicant's fingerprints and paperwork as well.

If an applicant has been printed by another employer and favorably adjudicated by the regulatory agency 150, those Pass results may also be shared between employers using the supplier access subsystem 110.

A copy of the original message may be stored in the data repository 100 and a copy of the submitted biometric data may be forwarded electronically through the regulatory access subsystem 140 to the regulatory agency 150. In turn, the regulatory agency 150 forwards the biometric data to the policing agency 151 as needed to perform various background and clearance checks. The regulatory agency 150 and/or the policing agency 151 may acknowledge receipt of the submittal through the regulatory access subsystem 140

Once verification may be complete, processing and billing information, along with individual identifying information may be automatically entered into the accounting sub-system. If the submitting entity has enough funds available to process the message submitted, the submitting entity's account may be debited.

Where an inked card 123 is provided, the open card 122 may be examined to verify that billing information is correct. The processing and billing information, along with individual identifying information may be manually keyed into the billing subsystem 160.

The billing subsystem 160 may also provide a monthly reconciliation to the regulatory agency 150 for submittals. For instance, each week, the billing subsystem 160 may send a deposit to regulatory agency 150 for items processed during the week. The regulatory agency 150 may receive periodic invoices (such as monthly) from the policing agency 151 for submittals processed through the biometric storage system 10. Embodiments of the present invention reconcile the invoice with the deposits, and store this data in an accounts database 161 as reconciliations 162. In the same way, the data used to form invoices may be stored as input data 163 and the deposits may be stored as collective payments 164.

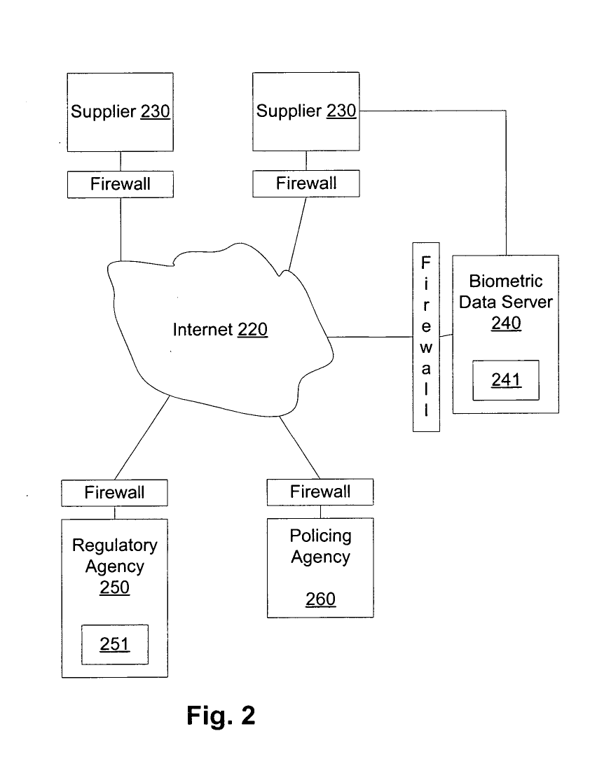

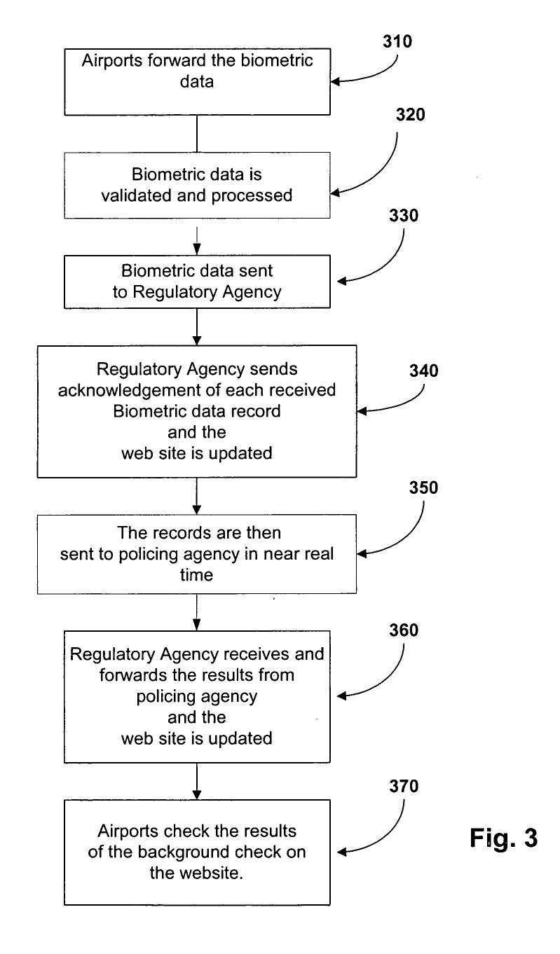

Referring now to FIG. 2, network 200 presenting a particular implementation of the biometric storage system 10 is now provided. It should be appreciated that the described system is provided merely exemplary and is not meant to limit the biometric data system 10 in anyway. Specifically, many known ways are currently known for establishing various databases and secure connections, as generally described above.

Returning to FIG. 2, a biometric information supplier 230 may connect to the biometric data server 240 through a physical network of consisting of several Primary Rate Interface (PRI) lines for dial-in users. Each PRI may be capable of 23 simultaneous connects and with three PRIs, the biometric data server 240 has 69 dial-in lines. Embodiments of the present invention also have 200 VPN connections available for user who wish to connect in this fashion. The Internet connection may be a subset of a main connection, such as T1 connections running Border Gateway Protocol (BGP). BGP allows all the lines to act as one. This feature provides more total bandwidth, but also gives a layer of redundancy for the external connection, since the three lines represent three separate upstream Internet Service Providers. The network may be a 100BaseT switched network, and PCs and servers may have either 100BaseT or 1000BaseT connections.

Continuing with FIG. 2, the PRI lines may be connected into two routers (such as Cisco model 3640). The PRI lines may be from two different telecommunications providers and may be in a hunt group so that the end user dials one phone number and the call may be answered by one of the available modems. The routers may be configured so that traffic from either router may be routed to a central location giving the biometric data server 240 redundancies in both hardware and in the PRI. Embodiments of the present invention have redundant VPN concentrators (such as Cisco model 3015), which can handle 200 simultaneous connections. The VPN concentrators may be augmented by a router (such as Cisco model 2621) to handle internal traffic from the VPN clients. This equipment, as well as the network servers and workstations, may be connected into enhanced switches (such as Cisco model 3550). These enhanced switches may be OSI layer 3 switches capable of a high rate of throughput and faster switching. Embodiments of the present invention have a Terminal Access Controller Access Control System (TACACS) and a Remote Authentication Dial-In User Service (RADIUS) server for dial-in and VPN authentication. TACACS allows a remote access server to communicate with an authentication server in order to determine if the user has access to the network. RADIUS is an authentication and accounting system used by many Internet Service Providers (ISPs). In particular, a username and password provided by a user are passed to a RADIUS server, which checks that the information is correct, and then authorizes access to the ISP system.

The biometric data server 240 may be a commercially available product such as Dell PowerEdge servers or HP/Compaq Proliant servers. These dual-processor based systems have 4 GB of RAM and may be running Microsoft Windows 2000 Advanced Server. All servers and arrays have redundant power supplies. The biometric data server 240 may further include the following components: (1) Mail/Application server operating with Microsoft Exchange 2000; (2) a database server using Microsoft SQL Server 2000, with an attached 1.8 TB RAID-5 array; (3) a Web/Application server with Apache 1.3.27 and Macromedia ColdFusion Server v 6.1; (4) a backup server running, for example, Veritas Backup Exec connected to a 8 TB tape storage system; and (5) a Domain Controller running Microsoft Active Directory.

Returning to FIG. 2, the network 200 may be protected by a network firewall running Checkpoint's FW-1 Small Business product. All the equipment may be connected to APC Uninterruptible Power Supply (UPS) and the UPSs may be plugged into a critical electrical panel, which has a generator backup system. The workstations associated with the biometric data server 240 may be Dell Optiplex systems running Windows 2000 Professional and Windows Office XP Professional.

Continuing with FIG. 2, the present invention may include Internet and intranet websites 241, such as those developed using Macromedia ColdFusion 6.1. The websites may be populated with information contained in multiple SQL databases, such as the above-described biometric database 100 and the accounts database 161. Thus, there may be also databases for the submittals processing information, the accounting information and the middleware between the submittal processing and the accounting system.

Referring now to FIG. 3, an electronic submittal comes to the biometric data server 240 from the suppliers 230 (either through the Internet 220 or a phone line), step 310. Then, a program called Mail-In-Module (MIM) associated with the biometric data server 240 reads the attached electronic print file, saves a copy to disk, and then opens the copied file.

In step 320, the biometric data server 240 may then parse the data and runs verification on the submittal. As described above, specific fields included with the biometric data may be verified, such as name, social security or identification number, address, etc. Further, the fields may be verified according to different standards. Preferably, the fields may be verified according to the above-described strict EFTS standard implemented by the Federal Bureau of Investigations (FBI). If the submittal passes verification, MIM writes the basic information necessary for accounting into a temporary database table, flagged as a new record. If the submittal does not pass verification, MIM writes the record to the temporary table, but also indicates an error code in the record.

An inked card may require manual intervention. When the inked cards arrive, they may be taken to a secure environment to opened and sorted into batches. The batches may be based on the supplier's customer ID and the billing type. An operator will enter the basic information necessary for tracking into the database 100, and the batch may be verified and submitted, as described above. The cards may be then scanned and submitted as an electronic submission. When received, the database 100 may be updated to indicate the inked card was received electronically. From this point forward, the submission may be processed as an electronic submission, in the above-described manner.

Continuing with step 320, the script in the biometric data server 240 detects the new record in the temporary table of the biometric database 100. This script may make certain prescribed changes, including error corrections, to one or more of several fields in order to bring the record's format into compliance with government standards. Next, the record may be transcribed into a permanent archive database table. Finally, the record's flag may be changed to indicate the record may be ready for mailing.

In step 330, another program in the biometric data server 240 known as Mail-Out-Module (MOM) scans the database 100 for completed records. If the completed record has been identified as an erroneous record, the MOM will notify the customer 230 of the error and writes the record into a special errors table of the database 100. If the record passed all verifications, MOM assembles the completed database record into a standard fingerprint submission file and performs a final verification to ensure that modifications made by the script have not rendered the file invalid. MOM then stores a copy in a permanent archive and submits the record to a regulatory agency 250.

At the same time, another SQL-stored procedure searches the biometric database 100 for any new records. If it sees a new record, the procedure checks the accounting system 160 to verify that the customer has enough funds to process the submittal. Each customer has an ID and there may be two billing types for each customer. If funds may be available, the process will update the biometric database 100 to show the submittal has processed. It will also create a batch in the accounting system 160, if necessary or add this record to an existing batch. It will also update a history table, which tracks all transactions and the associated supplier and personal identifiers for that transaction. This process may run periodically, such as every ten minutes.

During this time, a process in the biometric data server 240 reads the database 100 for processed records. This process then updates the database 100 to associate a tracking number with the biometric records.

The submitted biometric data may be forwarded to the regulatory agency 250 in step 330 by e-mail and the e-mail may be sent over an encrypted link. This process may run frequently, such as every three minutes. The regulatory agency 250 may return confirmation of the received biometric data (step 340) and the forward the data to a policing agency 260 for processing and examination (step 350). Typically, these transactions occur through the Internet 220.

Once processed, the regulatory agency 250 receives and returns results 251 from the policing agency 260. In step 360, the biometric data server 240 receives the results 251 and updates the website 251 to reflect the results 251. The supplier 230 may then access the website 241 to determine the status of the biometric processing the to determine the results of that processing, step 370.

Embodiments of the present invention have both an intranet for use by internal employees and an Internet site for access by customers/suppliers 230. All web interfaces may be written in Macromedia ColdFusion 6.1 or similar application and utilize database management system such as Microsoft SQL Server 2000 database for information storage.

The intranet allows service representatives to perform a variety of vital tasks. On the customer side, the intranet allows representatives to store and update client contact information. They may be able to check client account balances and process customer payments.

With the inked cards, staff may enter submission batches into the system through the intranet. The intranet may also be used to process status files from the regulatory agency 250. Reject handling and electronic submission rejects for these reports may be also done through the intranet. Representatives may be also able to search records that have been processed using the intranet. Available internal reports may include: Completed Batches, Completed Records, Rejected Records, Incomplete Records (records without enough funds to process) and Pending Batches (inked submissions not yet released).

All external-facing information for the biometric data server 240 may be contained within an Internet website. The site may present information on the biometric data server 240, authorized equipment vendors, updates on security initiatives with the Transportation community, and related links for other sites with pertinent information.

Individual clients 230 can access client-specific information as well. The security contact for each client may be allowed to log into the site and get a status of all records submitted. They can also see their account balance and a summary of how the money was spent. They may be able to download small sections (up to about 1000 submissions) in Microsoft Excel format to load onto their local systems for further processing. The client 230 may be able to contact the biometric data server 240 either by phone or through the Internet site. Each electronic contact request may be logged into a database and answered by a customer service representative through the intranet.

### Conclusion

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. Many embodiments of the invention can be made without departing from the spirit and scope of the invention.

1. A biometric data submission system comprising:
input means for accepting the biometric data;
quality check means for verifying that the biometric data conforms to a submission standard;
communication means for sending the verified biometric data for processing and for accepting processing results; and
database means for storing the verified biometric data and the processing results.

2. The biometric data submission system of claim 1 further comprising an output means for displaying data corresponding to the verified biometric data and the processing results.

3. The biometric data submission system of claim 1 further comprising billing means for monitoring submissions and processing of said biometric data and for associating charges with said submissions and processing.

4. The biometric data submission system of claim 3, wherein said communication means does not sending the biometric data for processing unless the billing means detects a sufficient balance for an associated submitter to pay for said charges.

5. The biometric data submission system of claim 1, wherein said biometric data acceptance input means comprises:
electronic data acceptance means for receiving and accepting electronically stored biometric data; and
physical data acceptance means for receiving physical biometric data and for converting said physical data to an electronic format for storage in said database means.

6. The biometric data submission system of claim 1, whereby said submission standard is Electronic Fingerprint Transmission Specification (EFTS).

7. A program storage medium readable by a machine, tangibly embodying a program of instructions executable by a machine to perform a biometric data submission method, the method having steps comprising:
accepting the biometric data;
verifying that the biometric data conforms to a submission standard;
sending the verified biometric data for processing and for accepting processing results; and
storing the verified biometric data and the processing results.

8. The program storage medium of claim 7, whereby the performed biometric data submission method further comprises displaying data corresponding to the verified biometric data and the processing results.

9. The program storage medium of claim 7, whereby the performed biometric data submission method further comprises:
monitoring submissions and processing of said biometric data, and
associating charges with said submissions and processing.

10. The program storage medium of claim 9, whereby the performed biometric data submission method further comprises delaying the biometric data for processing until detection of a sufficient balance to pay for said charges.

11. The program storage medium of claim 7, whereby method step of accepting the biometric data comprises:
receiving and accepting electronically stored biometric data; and
receiving physical biometric data and converting said physical data to an electronic format for storage in said database means.

12. The program storage medium of claim 7, whereby said submission standard is Electronic Fingerprint Transmission Specification (EFTS).

13. A biometric data submission method comprising:
accepting the biometric data;
verifying that the biometric data conforms to a submission standard;
sending the verified biometric data for processing and for accepting processing results; and
storing the verified biometric data and the processing results.

14. The biometric data submission method of claim 13 displaying data corresponding to the verified biometric data and the processing results.

15. The biometric data submission method of claim 13 further comprising:
monitoring submissions and processing of said biometric data, and
associating charges with said submissions and processing.

16. The biometric data submission method of claim 15, wherein the biometric data is not sent for processing unless the billing means detects a sufficient balance for an associated submitter to pay for said charges.

17. The biometric data submission method of claim 13, wherein the step of accepting the biometric data comprises
receiving and accepting electronically stored biometric data; and
receiving physical biometric data and converting said physical data to an electronic format for storage.

18. The biometric data submission method of claim 13, whereby said submission standard is Electronic Fingerprint Transmission Specification (EFTS).
